(19) United States
(12) Patent Application Publication
(10) Pub. No.: US 2010/0294860 A1
(43) Pub. Date: Nov. 25, 2010

(54) Flexible Shower Head with Temperature Sensors

(76) Inventor: Mei-Wei Hsieh, Caotun Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/470,561

(22) Filed: May 22, 2009

(51) Int. Cl. B05B 1/14

(52) U.S. Cl. 239/548

(57) ABSTRACT

A flexible shower head includes a water flowing means comprising an end coupling having inner threads; and a flexible, hollow head comprising an outer threaded annular extension adapted to threadedly secure to the inner threads for connecting the head and the water flowing means together, a plurality of holes, and at least one temperature sensor disposed on an outer surface. The extension is formed of metal. The head is spherical. The holes are arranged concentrically. The water flowing means may be replaced with a shower hose. The water flowing means may be replaced with a faucet. The water flowing means implemented as a fixed overhead shower water flowing means. The invention has benefits including durable, easy cleaning of mineral deposit, uniform spray, and water saving.

### BACKGROUND OF THE INVENTION

1. Field of Invention

The invention relates to shower heads and more particularly to a flexible shower head having at least one temperature sensor and improved characteristics including durable, easy cleaning of mineral deposit, uniform spray, and water saving.

2. Description of Related Art

Conventionally, a shower head is made of hard plastic or metal. However, the well known shower head suffers from several disadvantages. For example, mineral deposit may be formed in the water exit holes, resulting in a reduction water flow or non-uniform spray. Moreover, cleaning of the interior of the hard shower head is difficult. In addition, no temperature sensor is provided for visually indicating hotness or coldness of water to a person to be showered. Hence, it is typical for a person to use the hand to touch the shower head. This, however, is not safe if water in the shower head is very hot. Thus, a need for improvement exists.

### SUMMARY OF THE INVENTION

It is therefore one object of the invention to provide a flexible shower head comprising water flowing means comprising an end coupling having inner threads; and a flexible, hollow head comprising an outer threaded annular extension adapted to threadedly secure to the inner threads for connecting the head and the water flowing means together, a plurality of holes, and at least one temperature sensor disposed on an outer surface.

In a first aspect of the invention the extension is formed of metal;

In a second aspect of the invention the head is spherical.

In a third aspect of the invention the holes are arranged radially.

In a fourth aspect of the invention the holes are arranged concentrically.

In a fifth aspect of the invention the water flowing means is a shower hose.

In a sixth aspect of the invention the water flowing means is a faucet.

In a seventh aspect of the invention the water flowing means is a fixed overhead shower pipe.

By utilizing the invention, advantages including durable, easy cleaning of mineral deposit, uniform spray, and water saving can be obtained.

The above and other objects, features and advantages of the invention will become apparent from the following detailed description taken with the accompanying drawings.

### BRIEF DESCRIPTION OF THE DRAWINGS

FIG. 1 is a perspective view of a first preferred embodiment of flexible shower head according to the invention;

FIG. 2 is an exploded view of the flexible shower head;

FIG. 3 is a view similar to FIG. 1 showing fine streams of water being sprayed from the holes of the shower head;

FIG. 4 is a view similar to FIG. 3 showing the temperature sensors of the shower head being activated when spraying; and

FIG. 5 is a perspective view of the flexible shower head attached to a faucet in another configuration.

### DETAILED DESCRIPTION OF THE INVENTION

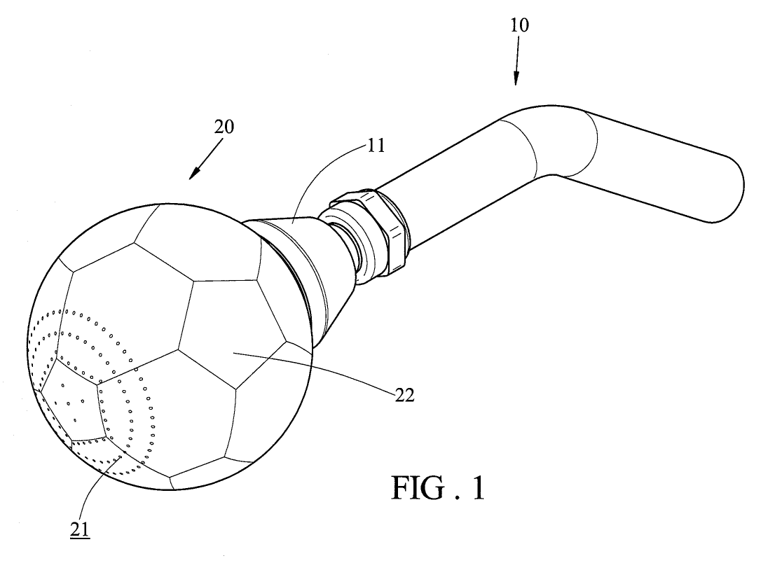

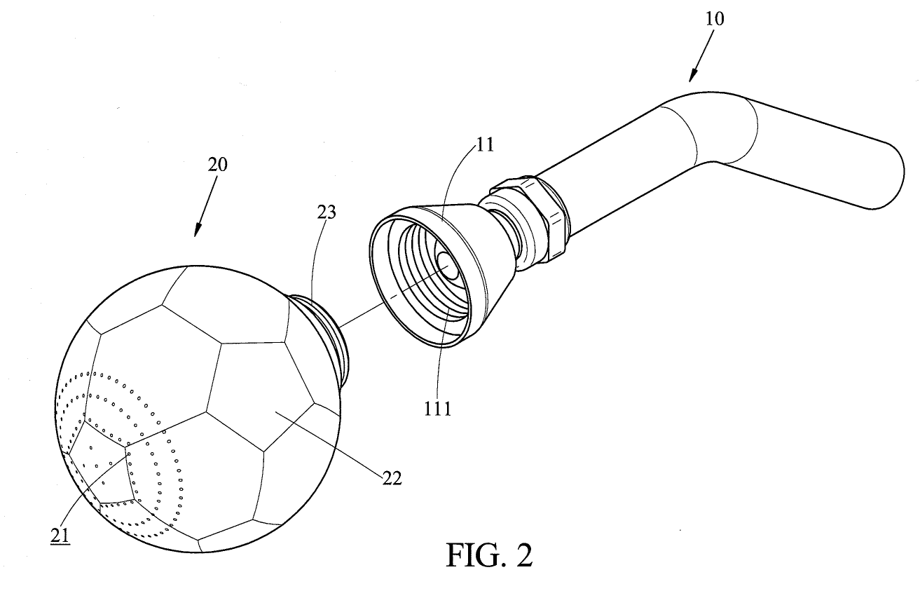

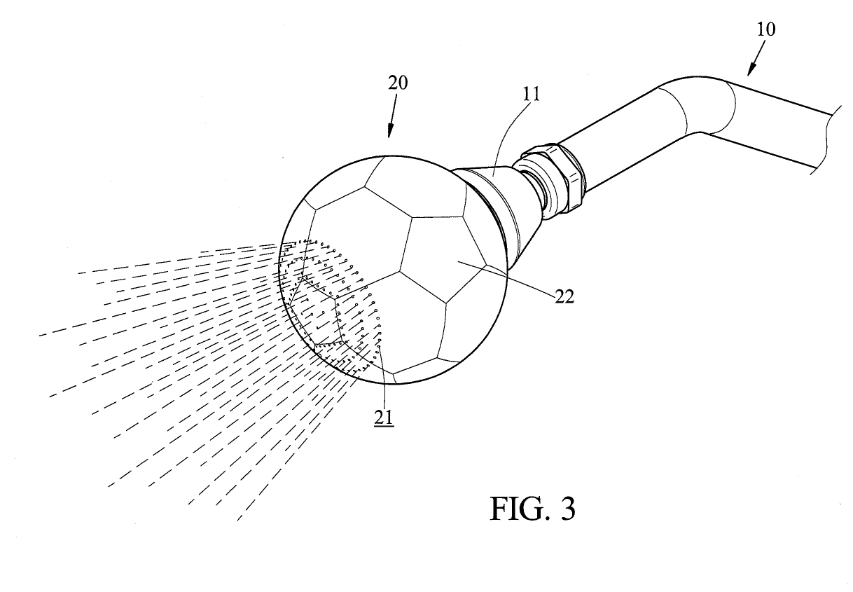

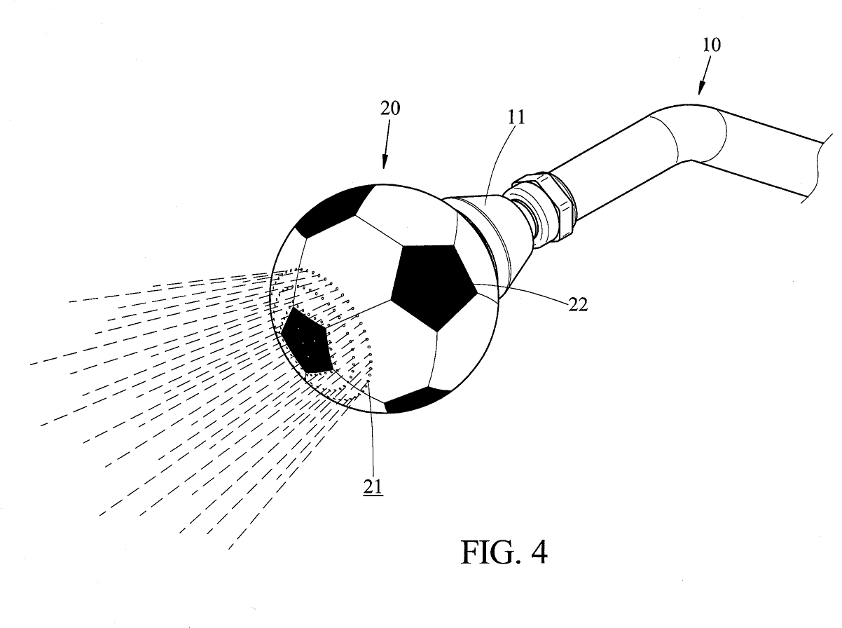

Referring to FIGS. 1 to 5, a flexible shower head in accordance with a preferred embodiment of the invention comprises the following components as discussed in detail below.

A water flowing means 10 comprises a substantially truncated conic end coupling 11 having inner threads 111. A hollow, spherical head 20 is made of soft rubber or plastic (i.e., the head 20 being flexible). The head 20 comprises an outer threaded annular extension 23 adapted to threadedly secure to the threads 111 for connecting the head 20 and the water flowing means 10 together. The head 20 further comprises a plurality of holes 21 opposite the extension 23, and a plurality of spaced temperature sensors 22 shaped as a pentagon provided on an outer surface.

Mineral deposit may be formed in the head 20 to block the holes 21 as the times of use increase. A person may press the head 20 to flexibly deform same and turn on a valve (not shown) to allow a large amount of water to suddenly flow through the head 20 via the water flowing means 10. As a result, the mineral deposit is easily removed. This feature can ensure a uniform spray all the time and thus save water. Moreover, the soft head 20 is durable and persons do not need to worry about the shower head being damaged because of falling onto the ground. Further, the temperature sensors 22 may change color, for example, from blue to red, for visually indicating that the water in the shower head is very hot when showering.

Preferably, the extension 23 is made of metal.

Preferably, the head 20 is shaped as a soccer ball.

Preferably, the holes 21 are arranged radially.

Preferably, the holes 21 are arranged concentrically or as a predetermined pattern.

Preferably, the water flowing means 10 is replaced with a shower hose.

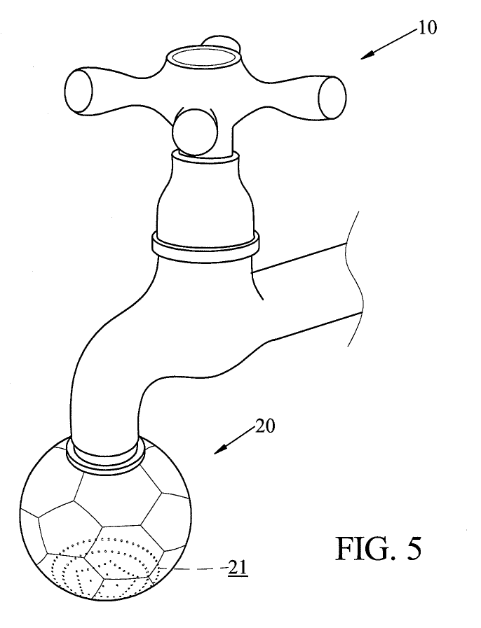

Preferably, the water flowing means 10 is replaced with a faucet (see FIG. 5).

Preferably, the water flowing means 10 is a fixed overhead shower water flowing means.

While the invention herein disclosed has been described by means of specific embodiments, numerous modifications and variations could be made thereto by those skilled in the art without departing from the scope and spirit of the invention set forth in the claims.

What is claimed is:

1. A flexible shower head comprising:
water flowing means (10) comprising an end coupling (11) having inner threads (111); and
a flexible, hollow head (20) comprising an outer threaded annular extension (23) adapted to threadedly secure to the inner threads (111) for connecting the head (20) and the water flowing means (10) together, a plurality of holes (21), and at least one temperature sensor (22) disposed on an outer surface,
wherein the extension (23) is formed of metal;
wherein the head (20) is spherical; and
wherein the holes (21) are arranged concentrically.

2. The flexible shower head of claim 1, wherein the water flowing means (10) is a shower hose.

3. The flexible shower head of claim 1, wherein the water flowing means (10) is a faucet.

4. The flexible shower head of claim 1, wherein the water flowing means (10) is a fixed overhead shower pipe.
